(19) United States
(12) Patent Application Publication
(10) Pub. No.: US 2003/0097418 A1
(43) Pub. Date: May 22, 2003

(54) Portable information communication terminal

(75) Inventor: Hiroyuki Yajima, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/294,673

(22) Filed: Nov. 15, 2002

(30) Foreign Application Priority Data
Nov. 16, 2001 (JP) 2001-351646JP

(51) Int. Cl. G06F 15/167

(52) U.S. Cl. 709/216; 709/213

(57) ABSTRACT

A portable information communication terminal connected to a storage-assisting server via a network, includes a storage-destination allocation determination unit for, in the event that capacity of a local storage unit of the portable information communication terminal was insufficient, determining whether or not existing data within the local storage unit is caused to move to the storage-assist sever connected to the network, and newly ensuring a storable region.

### BACKGROUND OF THE INVENTION

The present invention relates to a portable information communication terminal, and more particular to a portable information communication terminal that can be connected to a storage-assisting server via a network.

One example of a conventional information processing system was disclosed in JP-P1994-12357A. This conventional information processing system temporarily preserves data to be input from the outside in an external server connected by a LAN in the event that capacity of a memory within its own information terminal device was insufficient. Thereafter, at the moment that a shortage of capacity of the memory within the information processing terminal was removed, data was transmitted to the information processing terminal from the external server.

However, there are the following problems in the foregoing conventional system.

A first problem is that, also in the event of intending to perform a process with higher priority by use of data input from the outside, when the memory capacity within an information processing terminal device is insufficient, data is impossible to receive, and input data is temporarily preserved in the external server. For this reason, the process is impossible to perform until a shortage of capacity of the memory within the information terminal device is removed.

The reason is that, in the information processing terminal, data is constantly filed in the memory in the order of being input, whereby, even though data with high priority is input later, it is impossible to treat it.

A second problem is that, depending upon process contents of the information processing terminal, there is the case that the shortage situation of the memory capacity continues for a long period. In this case, data from the outside is not received completely.

The reason is that, in the event that data, of which size was larger than an open region of the memory within the information processing terminal device, continued to be input from the outside, only a process of preserving data to be input in the external server is performed, and data becomes impossible to receive in the information processing terminal device.

A third problem is that, in the event that, since there is much of data etc. preserved in the memory within the information processing terminal device, the process is not able to be performed due to a shortage of the memory capacity within the information processing terminal device, one part of data preserved in the memory has to be deleted so as to execute the process.

The reason is that, also in the event that a memory region necessary for executing the process in the information processing terminal is not able to be ensured due to an increase in quantity of use of the memory, no means for newly ensuring the memory region exists.

Prior arts for solving the foregoing problems were disclosed by JP-P2000-244555A and JP-P1999-284973A.

In JP-P2000-244555A was disclosed the art that was able to keep necessary electric mails easily even in the portable communication terminal of which the memory capacity was small. In a portable communication terminal 10, in filing the received electric mail in a mail-management region 21a of a RAM 21, indexed information that corresponds to the electric mail is prepared to file it in an index-management region 21b. In the event that the open region of the RAM 21 became insufficient, the electric mail filed in the mail-management region 21a is transmitted to a mail-keeping server 12 for keeping. As a result, the memory region of the RAM 21 can be opened. In the event of causing the portable communication terminal to transmit the electric mail kept in the mail-keeping server 12, the portable communication terminal transmits a fetch request to the mail-keeping server 12, based upon selection instruction for the indexed information filed in the index-management region 21b. The mail-keeping server 12, which received this fetch request, transmits to the portable communication terminal 10 the electric mail kept responding to the indexed information.

In such a manner, when the memory capacity becomes insufficient, the portable communication terminal causes data stored in the memory to take refuge in a host or a server for the time being. And the memory region that became open can be caused to store data.

Also, in JP-P1999-284973A was disclosed an information processing system in which picture recording of moving pictures was able to be made easily by use of the terminal device of which the memory capacity was small. The picture recording of the moving pictures is designated in terminal devices 302 and 302a. The moving pictures for which the picture recording is made by this designation are transferred to a host device 303 via communication means. And, the memory within the host device 303 is caused to store the transferred moving pictures.

In such a manner, the terminal device is a device that automatically causes the picture recording of the moving pictures to take refuge in the host, and thereafter reproduces the moving pictures for which the picture recording was made.

In the event that the memory capacity of the portable communication terminal or the terminal device became insufficient, however, in both Japanese Patent Applications, no storage-destination allocation was made for determining whether or not data stored in the memory of the portable communication terminal or the terminal device was caused to move to the external storage-assisting server via a network. Also, no optimum utilization of the memory of the portable terminal or the terminal device was made.

### DISCLOSURE OF THE INVENTION

The present invention lies in settling the above-mentioned problems.

A first invention for solving the above-mentioned problems is a portable information communication terminal connected to a storage-assisting server via a network, characterized in comprising storage-destination allocation determination means for, in the event that capacity of a local storage unit of said portable information communication terminal was insufficient, determining whether or not existing data within said local storage unit is caused to move to said storage-assist sever connected to the network, and newly ensuring a storable region.

A second invention for solving the above-mentioned problems is characterized in that, in the above-mentioned first invention, said storage-destination allocation determination means makes selection of existing data within said local storage unit, based upon a total access number to data, said existing data being caused to move to the external storage-assisting server.

A third invention for solving the above-mentioned problems is characterized in that, in the above-mentioned first invention, said storage-destination allocation determination means makes selection of existing data within said local storage unit, based upon a storage date of data, said existing data being caused to move to the external storage-assisting server.

A fourth invention for solving the above-mentioned problems is a portable information communication terminal connected to a storage-assisting server via a network, characterized in comprising:

determination means for, in the event that storage capacity of storage unit of said portable information communication terminal was insufficient, determining whether or not storage unit of said storage-assisting server is caused to store data stored in said storage means of said portable information communication terminal; and

means for, in the event that said determination means determined that said storage-assisting server was caused to store data, causing data stored in said storage unit of said portable information communication terminal to move to said storage unit of said storage-assisting server, and ensuring a new storage region in said storage unit of said portable information communication terminal.

A fifth invention for solving the above-mentioned problems is characterized in that, in the above-mentioned fourth invention, said determination means makes selection of said data to be caused to move, based upon a final access date to data, a total access number to data, or a storage date of data.

A sixth invention for solving the above-mentioned problems is characterized in that, in the above-mentioned fourth invention, said determination means is configured to determine, in the event that a new storage request was made, a storage destination based upon priority of contents of data for which this storage request was made, in the event that priority is low, to cause said storage-assisting server to store data, and in the event that priority is high, to cause said storage unit of said portable information communication terminal to store information.

A seventh invention for solving the above-mentioned problems is a portable information communication terminal connected to a storage-assisting server via a network, having: calculation process means for performing an information process; communication control means for making access to the network; and a local storage unit for storing/accumulating process result data of said calculation process means, further comprising:

storage-destination allocation determination means for determining whether the process result data is stored in said local storage unit, or is transferred to said external storage-assisting server via the network for storage, and in the event that capacity of said local storage unit was insufficient, determining whether or not data within said local storage unit is caused to move to the external storage-assisting server via said network; and

means for managing data of said local storage unit, and information caused to move to said external storage-assisting server.

A eighth invention for solving the above-mentioned problems is characterized in that, in the above-mentioned seventh invention, said storage-destination allocation determination means makes allocation of an information-storage destination, based upon priority of data contents to be caused to be stored.

A ninth invention for solving the above-mentioned problems is characterized in that, in the above-mentioned seventh invention, said storage-destination allocation determination means makes allocation of an data-storage destination, based upon open capacity of said local storage unit.

A tenth invention for solving the above-mentioned problems is characterized in that, in the above-mentioned seventh invention, said storage-destination allocation determination means makes selection of existing data within said local storage unit, based upon a final access date to data, said existing data being caused to move to the external storage-assisting server.

An eleventh invention for solving the above-mentioned problems is characterized in that, in the above-mentioned seventh invention, said storage-destination allocation determination means makes selection of existing data within said local storage unit, based upon a total access number to data, said existing data being caused to move to the external storage-assisting server.

A twelfth invention for solving the above-mentioned problems is characterized in that, in the above-mentioned seventh invention, said storage-destination allocation determination means makes selection of existing data within said local storage unit, based upon a storage date of data, said existing data being caused to move to the external storage-assisting server.

A thirteen invention for solving the above-mentioned problems is a portable information communication terminal connected to a storage-assisting server via a network, characterized in comprising:

a local storage unit for storing data;

selection means for, based upon priority of data for which a storage request was made, determining that either of said local storage unit or said storage-assisting server is caused to store data for which said storage request was made, determining so as to cause said local storage unit to store data for which said storage request was made, and yet, in the event that storage capacity of said local storage unit is insufficient, selecting existing data of said local storage unit, said existing data being caused to move to said external storage-assisting server;

means for causing the existing data of said local storage unit selected by said selection means to move to said storage-assisting server, and securing a new storage region in said local storage unit; and

means for managing information stored in said local storage unit, and data that said storage-assisting server was caused to store.

A fourteenth invention for solving the above-mentioned problems is characterized in, in the above-mentioned thirteenth invention, comprising:

management means for managing storage-destination information of data for which the storage request was made; and

means for, in the event that a read-out request of the stored data occurred, based upon storage-destination information managed by said management means, reading out data for which the read-out request was made.

A fifteenth invention for solving the above-mentioned problems is characterized in that, in the above-mentioned thirteenth invention, said selection means makes selection of said data to be caused to move, based upon a final access date to data, a total access number to data and a storage date of data.

A sixteenth invention for solving the above-mentioned problems is a portable information communication terminal connected to a storage-assisting server via a network, comprising: calculation process means for performing an information process; communication control means for making access to the network; and a work memory for storing/accumulating a process result of said calculation process means, further comprising:

transfer condition determination means for causing data within said work memory to move to the storage-assisting server via the network; and

means for managing data caused to move to said storage-assisting server.

A seventeenth invention for solving the above-mentioned problems is characterized in that, in the above-mentioned sixteenth invention, said transfer condition determination means allocates a storage destination of information to either of the work memory or the storage-assisting server via the network.

A eighteenth invention for solving the above-mentioned problems is characterized in that, in the above-mentioned sixteenth invention, said transfer condition determination means makes allocation of a storage destination of data, based upon priority of contents of data that the external storage-assisting server is caused to store.

A nineteenth invention for solving the above-mentioned problems is characterized in that, in the above-mentioned sixteenth invention, said transfer condition determination means makes allocation of a storage destination of data, based upon open capacity of the work memory.

A twentieth invention for solving the above-mentioned problems is characterized in that, in the above-mentioned sixteenth invention, said means for managing data requests transmission of data preserved in the storage-assisting server, based upon external storage information indicating a storage destination of information.

A twenty-first invention for solving the above-mentioned problems is a portable information communication terminal connected to a storage-assisting server via a network, having: calculation process means for performing an information process; communication control means for making access to the network; and a work memory for storing/accumulating a process result of said calculation process means, characterized in: further comprising:

a removable storage unit in said external storage-assisting server; and

a removable storage-device interface in said portable information communication terminal; and

causing accumulated data, for which a storage request was made by said portable information communication terminal, to be copied from the external storage-assisting server to said removable storage unit, and referring to the copied data by an interface for the removable storage unit.

A twenty-second invention for solving the above-mentioned problems is a system for temporarily preserving data of a portable information communication terminal in a storage-assisting server, said system being characterized in having: a storage-assisting server, the portable information communication terminal, and a network for connecting said storage-assisting server to said portable information communication terminal, said storage-assisting server comprising:

a removal storage unit for copying data preserved in the storage-assisting server; and

means for, in the event that a request was made by a user, or capacity of data preserved in the storage-assisting server reached a specification value, causing said storage-assisting server to copy data preserved in said removable storage unit, said portable information communication terminal having:

an interface for carrying out read-out of data copied to said removable storage unit; and

means for reading out data copied to said removable storage unit via said interface.

Specifically, the portable information communication system of the present invention is configured of a portable information communication terminal (1 of FIG. 1) and a storage-assisting server (10 of FIG. 1) connected hereto via a network (7 of FIG. 1). The storage-assisting server comprises a communication control device (12 of FIG. 1) for making access to the network, a selection control section (11 of FIG. 1) for inputting/outputting information into/from one or a plurality of storage devices, and a storage device group (13, 14 and 15 of FIG. 1) having extremely large storage capacity.

The portable information communication terminal comprises: an MPU (4 of FIG. 1) for performing an information process; a communication control section (3 of FIG. 1) for making access to the network; a storage-destination allocation determination section (6 of FIG. 1) for, by a predetermined criterion based upon priority of contents of data to be treated, and open capacity of a local storage device (5 of FIG. 1), determining that either of the local storage device of its own terminal, or the storage-assisting server is caused to store data; and an external storage information control section (2 of FIG. 1) for managing the storage destination of the stored data according to a determination result.

### BRIEF DESCRIPTION OF THE DRAWING

This and other objects, features and advantages of the present invention will become more apparent upon a reading of the following detailed description and drawings, in which:

FIG. 1 is a block diagram illustrating a system configuration of a first embodiment;

FIG. 2 is a flow chart illustrating an data storage operation;

FIG. 3 is a flow chart illustrating an data read-out operation;

FIG. 4 is a block diagram illustrating a system configuration of a second embodiment; and

FIG. 5 is a block diagram illustrating a system configuration of a third embodiment.

### DESCRIPTION OF THE EMBODIMENTS

Next, a first embodiment of the present invention will be explained in conjunction with the accompanied drawings.

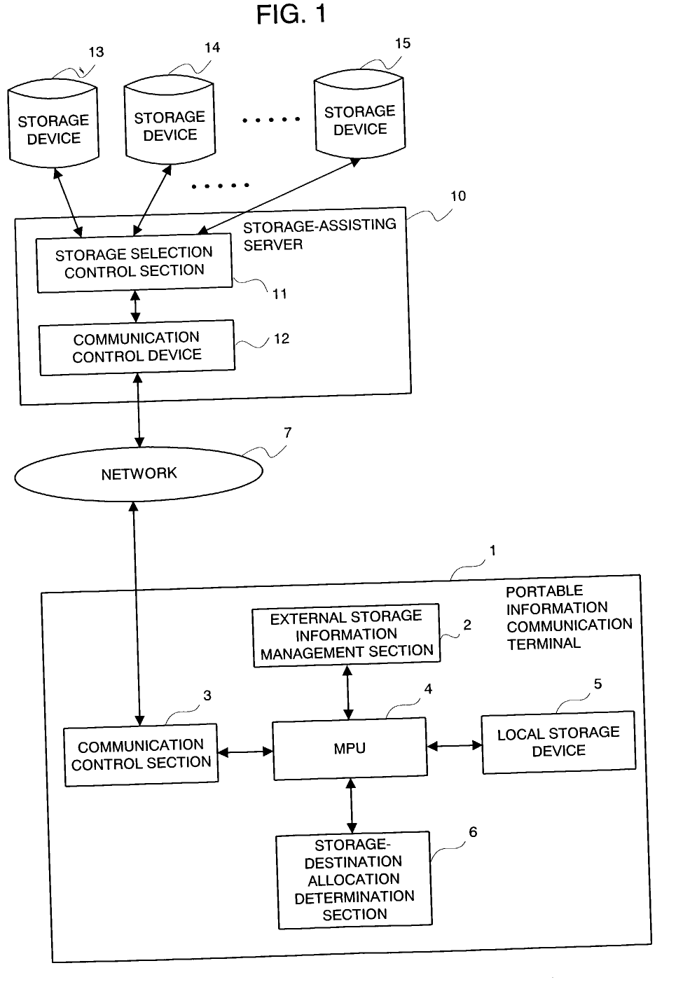

In FIG. 1, a portable information communication terminal 1 is connected to a storage-assisting server 10 via a network 7 by wire, wireless, or both thereof.

The portable information communication terminal 1 comprises an external storage information management section 2, a communication control section 3, an MPU 4, a local storage device 5, and a storage-destination allocation determination section 6.

The storage-assisting server 10 comprises a storage selection control section 11, a communication control device 12, and storage devices 13, 14, and 15. The external storage information management section 2 of the portable information communication terminal 1 is configured so as to manage management information associated with data stored by the storage-destination allocation determination section 6 in either of the local storage device 5 or the storage-assisting server 10. Herein, what is called the management information is storage-destination information indicating that data was stored in either of the local storage device 5 or the storage-assisting server 10, a file name, size, an ID, etc.

The communication control section 3 is configured so that the portable information communication terminal 1 performs a control process for making access to the network 7.

The MPU 4 is configured so as to perform an information process based upon data to be input from the outside, or data to be received from the local storage device 5 and the network 7.

The local storage device 5 is a device for storing data.

The storage-destination allocation determination section 6 is configured so as to determine that, in the event that an data-storage request occurred in the MPU 4, according to a predetermined criterion based upon priority of contents of data to be treated and open capacity of the local storage device 5, the storage destination of data is allocated to either of the local storage device 5, or the storage-assisting server 10. Herein, as an example of priority, a reference frequency of MPU 4 is considered. That is, in the event that the reference frequency of MPU 4 is high, the local storage device 5 is caused to store data. Also, as an example of priority, a degree of secrecy of data is considered. That is, in the event that the degree of secrecy of data is high, the local storage device 5 is caused to store data. As an example of the other priority, possibility of utilization of data, a request degree for immediate access to data, correlation with data stored in the local storage device 5, availability by the other portable information communication terminal, or priority established by each user, etc. are considered.

The storage selection control section 11 of the storage-assisting server 10 controls switching-over of an access destination of the storage devices 13, 14, and 15 connected to the storage-assisting server 10. Also, it controls write/read-out of data into/from the storage devices 13, 14, and 15. Further, in causing data to be stored, it makes selection of the optimum storage device, and so forth responding to open capacity of each storage device.

The communication control section 12 is configured so that the server 10 performs a control process for making access to the network 7.

The storage device group 13, 14, and 15 is a storage device having extremely large capacity.

Continuously, an operation of the above-mentioned configuration will be explained.

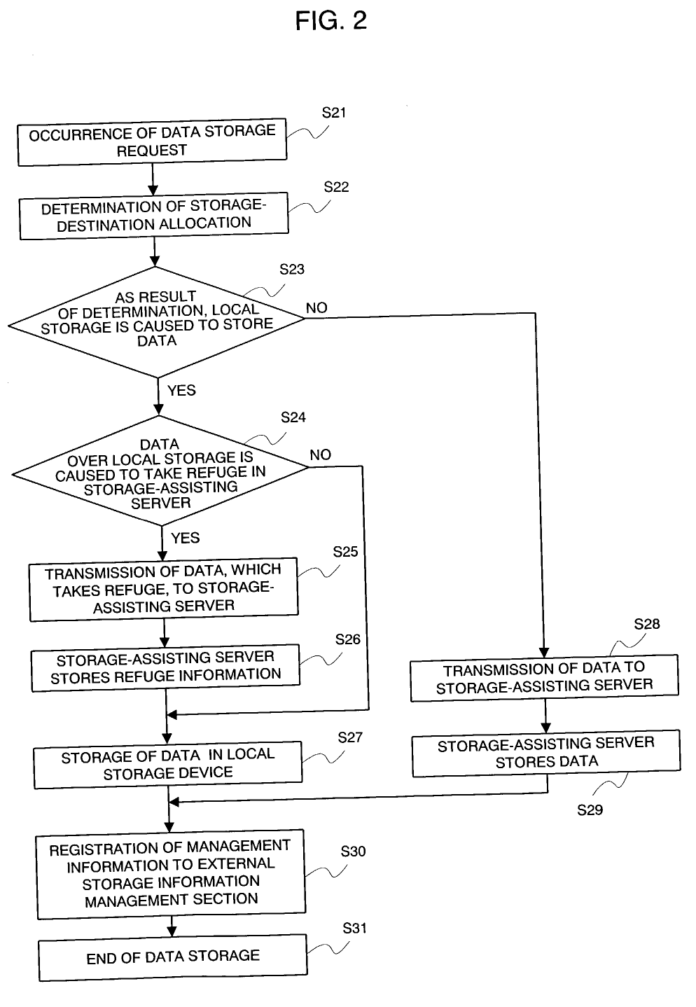

At first, an operation of the data storage of the portable information communication terminal 1 will be explained in conjunction with FIG. 1 and FIG. 2.

In the event that the storage request of data occurred in the portable information communication terminal 1 (S21), the storage-destination allocation determination section 6 judges priority responding to contents of data to be caused to be stored. According to this judgment result, it is judged that either of the local storage device 5 or the storage-assisting server 10 is caused to store data (S22). For example, the storage-destination allocation determination section 6 causes the local storage device 5 to store data having high priority (data of which the reference frequency by the MPU 4 is high). On the other hand, it judges so as to cause the storage-assisting server 10 to store data having low priority (data of which the reference frequency by the MPU 4 is low).

In the event that the storage-destination allocation determination section 6 judged so as to cause the storage-assisting server 10 to store data, data for which the storage request was made is transmitted to the storage-assisting server 10 via the network 7 (S28).

And, in the storage-assisting server 10, upon receiving data from the portable information communication terminal 1, the storage device selected by the storage selection control section 11 is caused to store this received data (S29).

On the other hand, in the event that the storage-destination allocation determination section 6 judged so as to cause the local storage device 5 to store data (S23), the MPU 4 compares a subtraction value obtained by subtracting capacity of data, which is desired to be caused to be stored, from storable open capacity of the local storage device 5 with a pre-determined criterion value.

In the event that the subtraction value is larger than the criterion value, the local storage device 5 is caused to store data for which the storage request was made (S27). Further, the MPU 4 registers management information such as the storage destination, the file name, the size, and the ID of data, which was caused to be stored, to the external storage information management section 2 (S30).

On the other hand, in the event that the subtraction value is smaller than the criterion value, so as to ensure a new storage region in the local storage device 5, data of which the capacity is equal to, or larger than storage capacity necessary for causing data, for which the storage request was made, to be stored is selected from data of the local storage device 5 according to a pre-specified condition. For example, the pre-specified condition is a condition for selecting data to which the final access date is the oldest. Also, the pre-specified condition is a condition for selecting data of which the stored date is the oldest. Also, the pre-specified condition is a condition for selecting data to which the total access number is the smallest. Further, the pre-specified condition is a condition for combining and selecting data to which the final access date is the oldest, data of which the stored date is the oldest, and data to which the total access number is the smallest.

And, the MPU 4 makes a transmission request to the storage-assisting server 10 from the communication control section 3 via the network 7 to transmit the selected data (S25).

Further, when the transmission request from the portable information communication terminal 1, and the selected data are received in the storage-assisting server 10, the storage devices 13, 14, and 15 that are caused to store data that the storage selection control section 11 received are selected. This selected storage device is caused to store the received data.

Thereafter, the MPU 4 changes the storage-destination information of the management information of the selected data registered in the external storage information management section 2 from the local storage device 5 to the storage-assisting server 10 (S27). And, the selected data is deleted from the local storage device 5. In such a manner, a new storage region is ensured in the local storage device 5.

Further, the MPU 4 causes the storage region ensured in the local storage device 5 to store data for which the storage request was made previously. The MPU 4 registers to the external storage information management section 2 the management information such as the storage destination, the file name, the size, the ID, etc. of information that the local storage device 5 was caused to store newly (S30). The storage operation of data is completed by this series of operations (S31).

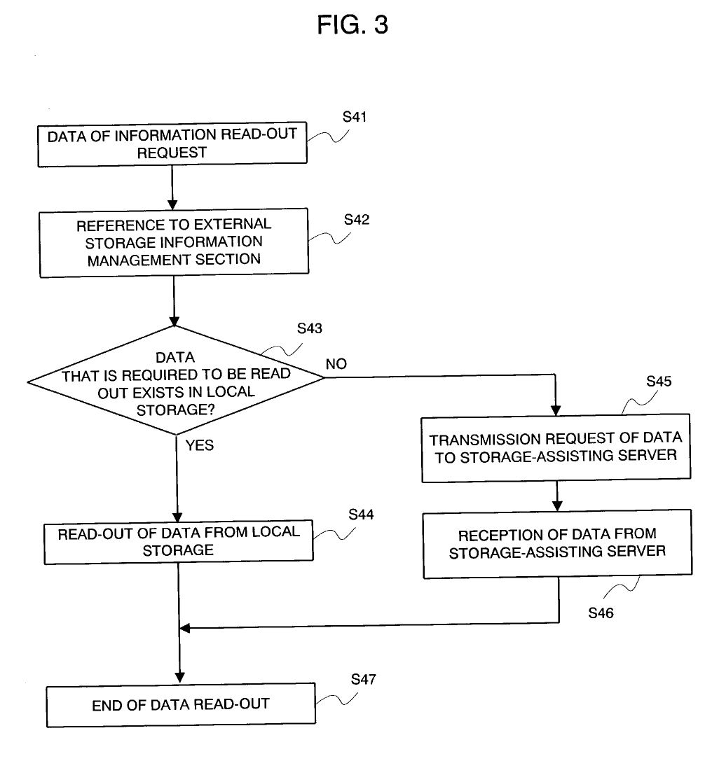

Next, a read-out operation of data stored in the portable information communication terminal 1 will be explained in conjunction with FIG. 1 and FIG. 3.

In the event that a read-out request of data occurred in the portable information communication terminal 1 (S41), reference is made to the management information registered in the external storage information management section 2 (S42). By referring to this management information, it is determined that data to be read out was registered in either of the local storage device 5 or the storage-assisting server 10 (S43).

In the event that data to be read out was stored in the local storage device 5, the MPU 4 reads out the corresponding data from the local storage device 5 (S44), and the read-out operation of data is completed in such a manner (S47).

On the other hand, in the event that data to be read out was stored in the storage-assisting server 10, the MPU 4 transmits an data-transmission request to the storage-assisting server 10 from the communication control section 3 via the network 7 (S45). The file name, the ID, etc. of information that is desired to be read out are included in this data-transmission request.

And, when the storage selection control section 11 of the storage-assisting server 10 receives the data-transmission request from the portable information communication terminal 1, it reads out the corresponding data from anyone of the storage devices 13, 14, and 15, based upon the file name and the ID included in this data-transmission request. This read-out data is transmitted to the communication control section 3 of the portable information communication terminal 1 from the storage-assisting server 10 via the network 7 (S46). The communication control section 3 of the portable information communication terminal 1 receives this transmitted data, and the MPU 4 loads it. In such a manner, the read-out operation of data is completed (S47).

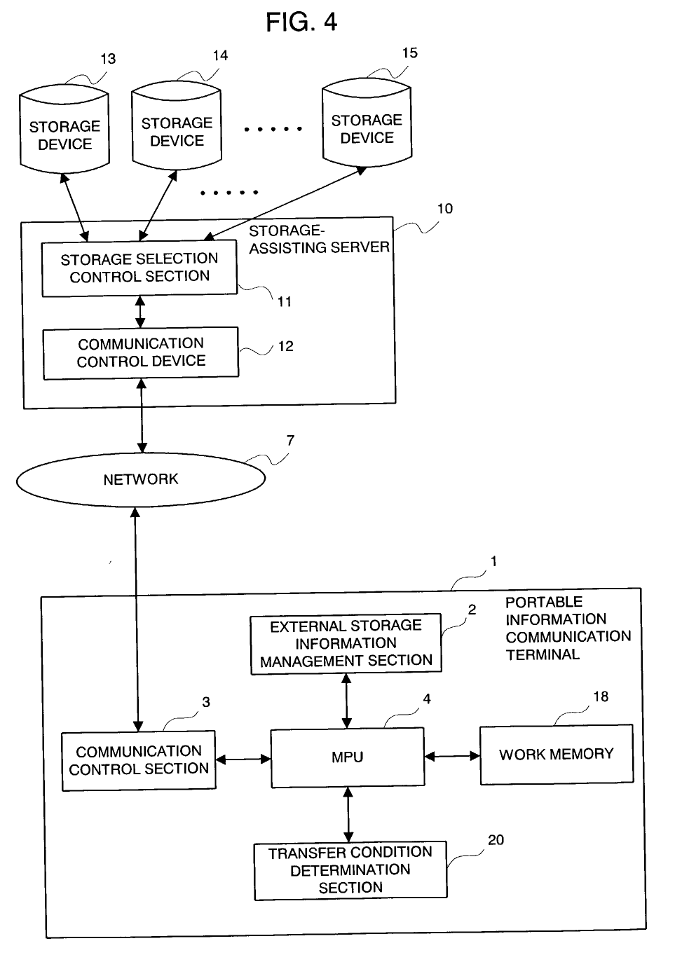

A second embodiment will be explained in conjunction with FIG. 4.

Instead of the local storage device 5 and the storage-destination allocation determination section 6 explained in the first embodiment, a work memory 18 and a transfer condition determination section 20 configure the portable information communication terminal 1. The other apparatus configuration is the same.

Additionally, a volatile memory such as a RAM (Random Access Memory) is considered as the work memory 18.

At first, in the event that the data-storage request occurred, the portable information communication terminal 1 constantly transmits data that is desired to be stored as a transmission request to the storage-assisting server 10 according to an allocation condition pre-established in the transfer-condition determination section 20. And, the MPU 4 registers the management information such as the file name, the size, the ID, etc. of the transmitted data to the external storage-information management section 2. The storage of data is completed in such a manner.

Additionally, the allocation condition pre-established in the transfer-condition determination section 20, which is a condition of, in the event that the data-storage request occurred, allocating the storage destination of data to either of the work memory 18 or the storage-assisting server 10, is established based upon priority of contents of data to be caused to be stored, and the open capacity of the work memory 18.

Next, in the event that an data read-out request occurred, the portable information communication terminal 1 transmits the data-transmission request to the storage-assisting server 10. As a result, the portable information communication terminal 1 receives information transmitted from the storage-assisting server 10 to cause the work memory 18 to store it. The read-out of data is completed in such a manner.

In accordance with the second embodiment, it becomes unnecessary to provide the local storage device in the portable information communication terminal, and the cost of the portable information communication terminal can be suppressed. Also, determination for allocating the storage destination is obviated, whereby the process can be simplified, and improvement of the process speed also can be expected.

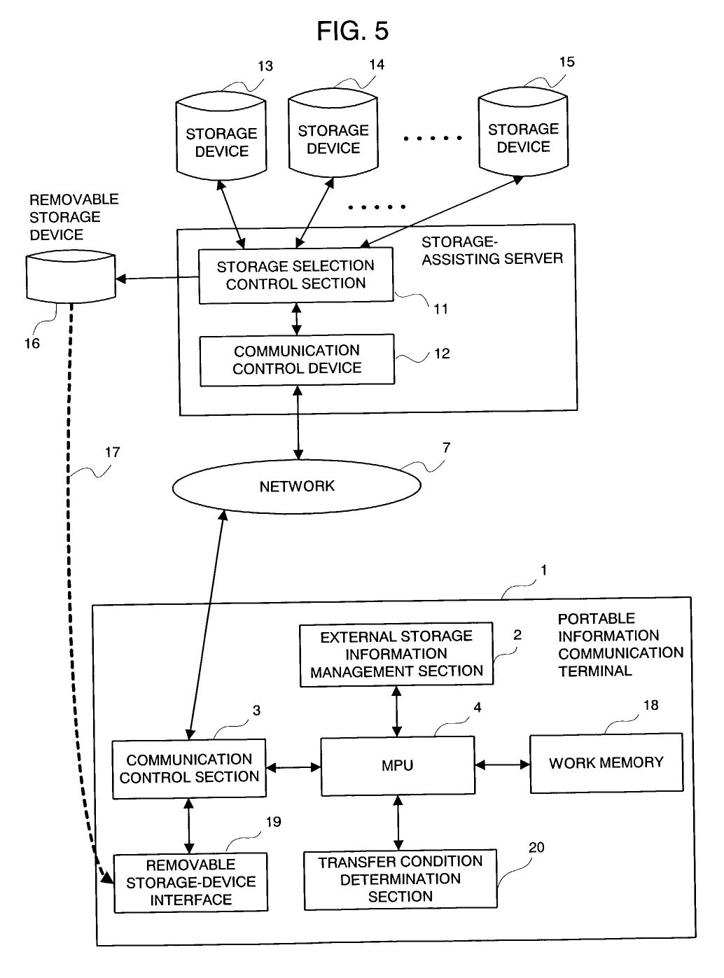

A third embodiment will be explained in conjunction with FIG. 5.

In the event that the data-storage request occurred, the portable information communication terminal 1 constantly transmits data that is desired to be stored as the transmission request to the storage-assisting server 10. And, the MPU 4 registers the management information of data transmitted to the storage-assisting server 10 to the external storage information management section 2.

On the other hand, the storage-assisting server 10 causes anyone of the storage devices 13, 14, and 15 to store data from the portable information communication terminal 1.

By the way, the portable information communication terminal 1 does not read out data, which the storage decices 13, 14, and 15 of the storage-assisting server 10 were to store, via the network.

The read-out of data, which the storage devices 13, 14, and 15 of the storage-assisting server 10 were caused to store, is carried out at the moment that capacity of data stored in the storage devices 13, 14, and 15 of the storage-assisting server 10 reached a specification quantity, or at the request of a user of this system. Specifically, data for which the storage request was made from the portable information communication terminal 1 is copied, or caused to move to a removable storage device 16 from the storage devices 13, 14, and 15. This removable storage device 16 is moved to the portable information communication terminal of this system by use of a transportation section 17 such as door-to-door delivery, and mail.

And, the removable storage device 16 is connected to a removal storage-device interface 19 of the portable information communication terminal 1. As a result, the portable information communication terminal 1 can refer to information caused to be stored till then from the removable storage device 16.

The third embodiment is suitable for application in which the read-out of data that the storage-assisting server 10 was caused to store is not normally carried out. For example, operation recording (log), saving of supervision information, and so forth.

As mentioned above, the present invention has the following effects.

A first effect is that, even in the situation that storable open capacity is not almost present in the local storage device of the portable information communication terminal, information having high priority, etc. can be stored.

The reason is that, in the event that the open capacity of the local storage device is insufficient, by causing data stored in the local storage to move to the storage-assisting server, a new storage region can be ensured.

The second effect is that, even though the open capacity of the local storage device became insufficient during the use of this system, data can be caused to be stored.

The reason is that, in the event that the open capacity of the local storage device is insufficient, the storage-assisting server is caused to store data.

The third effect is that the cost of the portable information communication terminal can be reduced.

The reason is that utilization of the storage-assisting server in the network destination allows the local storage capacity of the portable information communication terminal to be reduced.

The fourth effect is that the portable information communication terminal of this system does not need to be conscious of the storage destination of data.

The reason is that the allocation of the data-storage destination is automatically carried out by this system.

The entire disclosure of Japanese Patent Application No. 2001-351646 filed on Nov. 16, 2001 including specification, claims, drawing and summary are incorporated herein by reference in its entirety.

What is claimed is:

1 A portable information communication terminal connected to a storage-assisting server via a network, comprising storage-destination allocation determination means for, in the event that capacity of a local storage unit of said portable information communication terminal was insufficient, determining whether or not existing data within said local storage unit is caused to move to said storage-assist sever connected to the network, and newly ensuring a storable region.

2 The portable information communication terminal set forth in claim 1,
wherein said storage-destination allocation determination means makes selection of existing data within said local storage unit, based upon a total access number to data, said existing data being caused to move to the external storage-assisting server.

3 The portable information communication terminal set forth in claim 1,
wherein said storage-destination allocation determination means makes selection of existing data within said local storage unit, based upon a storage date of data, said existing data being caused to move to the external storage-assisting server.

4 A portable information communication terminal connected to a storage-assisting server via a network, comprising:
determination means for, in the event that storage capacity of storage unit of said portable information communication terminal was insufficient, determining whether or not storage unit of said storage-assisting server is caused to store data stored in said storage unit of said portable information communication terminal; and
means for, in the event that said determination means determined that said storage-assisting server was caused to store data, causing data stored in said storage unit of said portable information communication terminal to move to said storage unit of said storage-assisting server, and ensuring a new storage region in said storage unit of said portable information communication terminal.

5 The portable information communication terminal set forth in claim 4,
wherein said determination means makes selection of said data to be caused to move, based upon a final access date to data, a total access number to data, or a storage date of data.

6 The portable information communication terminal set forth in claim 4,
wherein said determination means is configured to determine, in the event that a new storage request was made, a storage destination based upon priority of contents of data for which this storage request was made, in the event that priority is low, to cause said storage-assisting server to store data, and in the event that priority is high, to cause said storage unit of said portable information communication terminal to store data.

7 A portable information communication terminal connected to a storage-assisting server via a network, having: calculation process means for performing an information process; communication control means for making access to the network; and a local storage unit for storing/accumulating process result data of said calculation process means, further comprising:
storage-destination allocation determination means for determining whether the process result data is stored in said local storage unit, or is transferred to said external storage-assisting server via the network for storage, and in the event that capacity of said local storage unit was insufficient, determining whether or not data within said local storage unit is caused to move to the external storage-assisting server via said network; and
means for managing data of said local storage unit, and data caused to move to said external storage-assisting server.

8 The portable information communication terminal set forth in claim 7,
wherein said storage-destination allocation determination means makes allocation of an data-storage destination, based upon priority of data contents to be caused to be stored.

9 The portable information communication terminal set forth in claim 7,
wherein said storage-destination allocation determination means makes allocation of an data-storage destination, based upon open capacity of said local storage unit.

10 The portable information communication terminal set forth in claim 7,
wherein said storage-destination allocation determination means makes selection of existing data within said local storage unit, based upon a final access date to data, said existing data being caused to move to the external storage-assisting server.

11 The portable information communication terminal set forth in claim 7,
wherein said storage-destination allocation determination means makes selection of existing data within said local storage unit, based upon a total access number to data, said existing data being caused to move to the external storage-assisting server.

12 The portable information communication terminal set forth in claim 7,
wherein said storage-destination allocation determination means makes selection of existing data within said local storage unit, based upon a storage date of data, said existing data being caused to move to the external storage-assisting server.

13 A portable information communication terminal connected to a storage-assisting server via a network, comprising:
a local storage for storing data;
selection means for, based upon priority of data for which a storage request was made, determining that either of said local storage unit or said storage-assisting server is caused to store data for which said storage request was made, determining so as to cause said local storage unit to store data for which said storage request was made, and yet, in the event that storage capacity of said local storage unit is insufficient, selecting existing data of said local storage unit, said existing data being caused to move to said storage-assisting server;
means for causing the existing data of said local storage unit selected by said selection means to move to said storage-assisting server, and securing a new storage region in said local storage; and
means for managing data stored in said local storage unit, and data that said storage-assisting server was caused to store.

14 The portable information communication terminal set forth in claim 13, comprising:
management means for managing storage-destination information of data for which the storage request was made; and
means for, in the event that a read-out request of the stored data occurred, based upon storage-destination information managed by said management means, reading out data for which a read-out request was made.

15 The portable information communication terminal set forth in claim 13,
wherein said selection means makes selection of said data to be caused to move, based upon a final access date to data, a total access number to data, and a storage date of data.

16 A portable information communication terminal connected to a storage-assisting server via a network having: calculation process means for performing an information process; communication control means for making access to the network; and a work memory for storing/accumulating a process result of said calculation process means, further comprising:
transfer condition determination means for causing data within said work memory to move to the storage-assisting server via the network; and
means for managing data caused to move to said storage-assisting server.

17 The portable information communication terminal set forth in claim 16,
wherein said transfer condition determination means allocates a storage destination of data to either of the work memory or the storage-assisting server via the network.

18 The portable information communication terminal set forth in claim 16,
wherein said transfer condition determination means makes allocation of a storage destination of data, based upon priority of contents of data that the external storage-assisting server is caused to store.

19 The portable information communication terminal set forth in claim 16,
wherein said transfer condition determination means makes allocation of a storage destination of data, based upon open capacity of the work memory.

20 The portable information communication terminal set forth in claim 16,
wherein said means for managing data requests transmission of data preserved in the storage-assisting server, based upon external storage information indicating a storage destination of data.

21 A portable information communication terminal connected to a storage-assisting server via a network, having: calculation process means for performing an information process; communication control means for making access to the network; and a work memory for storing/accumulating a process result of said calculation process means, further comprising:
a removable storage unit in said external storage-assisting server; and
a removable storage-device interface in said portable information communication terminal, and
causing accumulated data, for which a storage request was made by said portable information communication terminal, to be copied from the external storage-assisting server to said removable storage unit, and referring to the copied data by an interface for the removable storage unit.

22 A system for temporarily preserving data of a portable information communication terminal in a storage-assisting server, said system comprising:
a storage-assisting server; the portable information communication terminal; and a network for connecting said storage-assisting server to said portable information communication terminal, said storage-assisting server comprising:
a removal storage unit for copying data preserved in the storage-assisting server; and
means for, in the event that a request was made by a user, or capacity of data preserved in the storage-assisting server reached a specification value, causing said removable storage unit to copy data preserved in said storage-assisting server, said portable information communication terminal having:
an interface for carrying out read-out of data copied to said removable storage unit; and
means for reading out data copied to said removable storage unit via said interface.
